(19) United States
(12) Patent Application Publication
(10) Pub. No.: US 2020/0180937 A1
(43) Pub. Date: Jun. 11, 2020

(54) APPARATUS AND METHOD FOR LIQUID DISPENSING USING OPTICAL TIME OF FLIGHT SENSOR

(71) Applicant: A.C. Dispensing Equipment Inc., Lower Sackville (CA)

(72) Inventors: Micah FRITH, Halifax (CA); Anthony ALKINS, Halifax (CA); Greg ERMAN, Chezzetcook (CA); Derek COLE, Lower Sackville (CA); Ian MACLEAN, Fall River (CA)

(21) Appl. No.: 16/706,123

(22) Filed: Dec. 6, 2019

Related U.S. Application Data
(60) Provisional application No. 62/776,656, filed on Dec. 7, 2018.

(51) Int. Cl. B67D 3/00; G01F 23/292; G01S 7/4865; G01S 7/484; G01S 7/48; G01S 17/08

(52) U.S. Cl. CPC B67D 3/0093; B67D 3/0077; B67D 3/0041; G01S 17/08; G01S 7/4865; G01S 7/484; G01S 7/4802; G01F 23/2928

(57) ABSTRACT

An apparatus and method are provided for optical liquid level determination in a liquid dispensing system. Accurate volume dispensing based on the level determination is also provided. An optical sensor device emits a light signal downward into the tank toward the liquid, and received a portion of the light signal that has been reflected upwardly by a surface at the top of the liquid. A processing system calculates the height of the liquid in the tank based on a time of flight measurement of the light signal. A head pressure of the liquid over a controllable dispensing valve located at the bottom of tank may then be calculated using the calculated height of the liquid in the tank. An open time for the controllable dispensing valve is then calculated, based on the calculated head pressure, in order to dispense a predetermined volume of liquid from the tank.

### CROSS REFERENCE TO RELATED APPLICATIONS

This application claims the benefit of priority of U.S. Provisional Patent Application No. 62/776,656 filed on Dec. 7, 2018, which is incorporated herein by reference.

### FIELD

The present disclosure relates generally to liquid dispensing systems. More particularly, the present disclosure relates to liquid tank level determination and accurate volume dispensing for liquid dispensing systems.

### BACKGROUND

In gravity aided liquid dispensing systems, such as for dispensing dairy products, the pressure (referred to as head pressure) of the liquid over the dispensing valve at the bottom of the tank changes with the liquid column height. Accordingly, the rate of flow of liquid through the dispensing valve changes as the head pressure decreases. Those skilled in the art will understand there are well known mathematical calculations which can be made to determine how much time is required to dispense via gravity, an approximate volume of a liquid having known properties from a tank of known dimensions through an outlet of known dimensions, when a weight or height level of the liquid in the tank is known. Therefore having knowledge of the liquid level allows for adjustment of the opening time of the valve to obtain a substantially constant volume of dispensed dairy product.

In certain applications, such as dairy dispensing for coffee consumption, it is necessary to dispense predetermined volumes, or shots, of dairy product for consistent user taste experience, where different predetermined volumes of dairy product can be selected for dispensing. Hence, accuracy in determining the liquid level in the tank is critical for ensuring consistent volumes of the dairy product are dispensed as the tank drains. It is well-known that the flow rate of liquid through an outlet via gravity changes as the head pressure changes due to the drop in liquid in the tank.

Currently known solutions for determining the level of liquid in a tank include the use of a reset button, where this requires the user to fill to a line and then press a reset button until the displayed value matches the fill level. If the user forgets to press the reset button, the microprocessor of the dispensing system still considers the level to be near the bottom of the tank, and subsequently over-dispenses. Another known solution includes the use of one or more load cells or pressure sensors to measure the weight of the tank and its content to assess the pressure caused by the liquid on the dispensing valve at the front of the dispenser, There are several disadvantages to using load cells in such an application when it comes to weighing the tank and its content. For example, the calibration of the load cells may need to take into account temperature, as the liquid to be dispensed can be refrigerated, warm, or left at ambient temperature. Accumulation of residual product on the walls of the tank will adversely affect the measurements, load cells have a tendency to drift over time, requiring frequent calibration and correction is required if measurements are performed at the back of the dispenser and if the tank bottom is slightly inclined toward the front of the dispenser, and/or if the dispenser itself is not at level.

Other issues can include variability of tank weight when they are changed, which can affect the calibration and may require a zero point setting operation. Converting from mass to liquid column height can induce errors as well, based on potential inconsistent geometry of the liquid container caused by production variances, aging, or future design changes. Converting from mass to liquid column height also introduces potential errors and the complexity of having to consider the specific gravity of the liquid.

Hence, optical based liquid level detection systems have been proposed. Some known optical liquid level detection systems require immersion of the detector itself into the liquid of the tank, which is highly undesirable and sometimes not permitted in applications where the stored liquid is to be consumed as contamination of the liquid can occur if the detector is not properly cleaned. The use of photodiodes affixed to the dairy container to sense ambient light or light from light sources such as LED and laser diode have also been proposed. There are multiple drawbacks to such known optical liquid level detection systems.

Improvements in liquid level determination systems are therefore desired.

The above information is presented as background information only to assist with an understanding of the present disclosure. No assertion or admission is made as to whether any of the above, or anything else in the present disclosure, unless explicitly stated, might be applicable as prior art with regard to the present disclosure.

### SUMMARY

According to an aspect, the present disclosure is directed to an apparatus for use in a liquid dispensing system, comprising an optical sensor device disposable at a top side of a tank of the dispensing system, the optical sensor device comprising a light source for emitting a light signal downward into the tank toward a liquid in the tank, a light sensor for receiving a portion of the light signal that has been reflected upwardly by a surface at a top of the liquid, a processing system for measuring a time of flight of the light signal from the light source down to the surface at the top of the liquid and back up to the light sensor, and for calculating the height of the liquid in the tank using the time of flight measurement and a known distance between the optical sensor device and a bottom of the tank, and for outputting an electrical signal representing the calculated height of the liquid.

In an embodiment, the processing system is configured to calculate a head pressure of the liquid over a controllable dispensing valve located at the bottom of tank using the calculated height of the liquid in the tank.

In an embodiment, the processing system is configured to calculate an open time for the controllable dispensing valve, based on the calculated head pressure, in order to dispense a predetermined volume of liquid from the tank.

In an embodiment, the processing system generates, in response to a dispense request, a signal to initiate the opening of the controllable dispensing valve for a duration of the calculated open time to dispense the predetermined volume of liquid.

In an embodiment, the surface for reflecting a portion of the light signal s an upper surface of the liquid.

In an embodiment, the apparatus further comprises a reflective float disposable within the tank for floating at the surface of the liquid, wherein the surface at the top of the liquid for reflecting the light is a surface of the reflective float.

In an embodiment, the apparatus further comprises a guide for retaining the reflective float in substantial vertical alignment with the optical sensor device.

In an embodiment, the apparatus further comprises a sensor for measuring an angle of inclination of the apparatus from level, wherein the processing system is further configured to adjust the calculated height of the liquid in the tank based on the measured angle.

In an embodiment, the optical sensor device is a time of flight laser device.

According to an aspect, the present disclosure is directed to a method comprising providing an optical sensor device, comprising a light source and a light sensor, at a top side of a tank of a dispensing system, emitting, using the light source, a light signal downward into the tank toward a liquid in the tank, receiving, using the light sensor, a portion of the light signal that has been reflected upwardly by a surface at a top of the liquid, measuring, using a processing system, a time of flight of the light signal from the light source down to the surface and back up to the light sensor, calculating, using the processing system, the height of the liquid in the tank using the time of flight measurement and a known distance between the optical sensor device and a bottom of the tank, outputting, using the processing system, an electrical signal representing the calculated height of the liquid.

In an embodiment, the method further comprises calculating a head pressure of the liquid over a controllable dispensing valve located at the bottom of tank using the calculated height of the liquid in the tank.

In an embodiment, the method further comprises calculating an open time for the controllable dispensing valve, based on the calculated head pressure, in order to dispense a predetermined volume of liquid from the tank.

In an embodiment, the method further comprises generating, in response to a dispense request, a signal to initiate the opening of the controllable dispensing valve for a duration of the calculated open time to dispense the predetermined volume of liquid.

In an embodiment, the surface for reflecting a portion of the light signal is an upper surface of the liquid.

In an embodiment, the surface at the top of the liquid for reflecting the light is a surface of a reflective float disposed within the tank.

In an embodiment, the method further comprises guiding the reflective float within the tank to retain the reflective float in substantial vertical alignment with the optical sensor device.

In an embodiment, the method further comprises measuring, using a sensor, an angle of inclination of the dispensing system from level, and adjusting, using the processing system, the calculated height of the liquid in the tank based on the measured angle.

In an embodiment, the emitting the light signal comprises emitting a laser beam.

The foregoing summary provides some aspects and features according to the present disclosure but is not intended to be limiting. Other aspects and features of the present disclosure will become apparent to those ordinarily skilled in the art upon review of the following description of specific embodiments in conjunction with the accompanying figures. Accordingly, the drawings and detailed description are to be regarded as illustrative in nature and not restrictive.

### BRIEF DESCRIPTION OF THE DRAWINGS

Embodiments of the present disclosure will now be described, by way of example only, with reference to the attached Figures.

FIG. 1 is a diagram showing a side view of an example liquid dispensing apparatus with an optical liquid height measuring system, according to a present embodiment.

FIG. 2 is a front view of the embodiment of FIG. 1.

FIG. 3 is a diagram of an example optical sensor device disposed at an upper opening of a tank.

FIG. 4A is a diagram of a lid or top of a tank and a sensor housing for receiving an optical sensor device.

FIG. 4B is a diagram of the sensor housing of FIG. 4A engaged with the lid of the tank.

FIG. 5A is an exploded bottom perspective view of a simple block representation of a sensor housing.

FIG. 5B is a view of a first side of an embodiment of a sensor cover.

FIG. 5C is a view of a second side of the sensor cover of FIG. 5B.

FIG. 5D is a side view of the sensor cover of FIG. 5B.

FIG. 5E is a side view of an optical sensor device positioned at a recess of a sensor cover.

FIG. 6 is a process flow diagram of an example method according to an embodiment of the present disclosure.

FIG. 7A is a diagram of an example optical liquid height measuring system having a reflective float,

FIG. 7B is an enlarged view of the reflective float at the surface of the liquid,

FIG. 8 is top cross sectional view of the tank taken along line 8-8 in FIG. 7A.

FIG. 9 is a diagram similar to the one of FIG. 7A except that the dispensing apparatus is not level to ground.

FIG. 10 is a block diagram of an example electronic device,

The relative sizes and relative positions of elements in the drawings are not necessarily drawn to scale. For example, the shapes of various elements and angles are not necessarily drawn to scale, and some of these elements may be arbitrarily enlarged and/or positioned to improve the readability of the drawings. Further, the particular shapes of the elements as drawn are not necessarily intended to convey any information regarding the actual shape of the particular elements, and have been solely selected for ease of recognition in the drawings.

### DETAILED DESCRIPTION

This disclosure generally relates to apparatuses, methods, and systems for optical liquid level determination in a dispensing apparatus having a tank, and to accurate volume dispensing based on the level determination. In an aspect, an optical sensor device is provided comprising a light source and a light sensor. The optical sensor device is disposed at a top side of a tank of the dispensing system. A light source emits a light signal downward into the tank toward the liquid. A light sensor receives a portion of the light signal that has been reflected upwardly by a surface at the top of the liquid. A processing system measures a time of flight of the light signal from the light source down to the surface and back up to the light sensor. The processing system then calculates the height of the liquid in the tank using the time of flight measurement and a known distance between the optical sensor device and a bottom of the tank. A head pressure of the liquid over a controllable dispensing valve located at the bottom of tank may then be calculated using the calculated height of the liquid in the tank. An open time for the controllable dispensing valve is then calculated, based on the calculated head pressure, in order to dispense a predetermined volume of liquid from the tank.

The terms “liquid level” and “liquid height” are generally used interchangeably herein.

An optical time of flight liquid height determination may provide a simple yet accurate height determination, which may be used to calculate a valve open time for the accurate dispensing of a predetermined volume of liquid from the dispenser.

The relative sizes and relative positions of elements in the drawings are not necessarily drawn to scale. For example, the shapes of various elements and angles are not necessarily drawn to scale, and some of these elements may be arbitrarily enlarged and/or positioned to improve the readability of the drawings. Further, the particular shapes of the elements as drawn are not necessarily intended to convey any information regarding the actual shape of the particular elements, and have been solely selected for ease of recognition in the drawings.

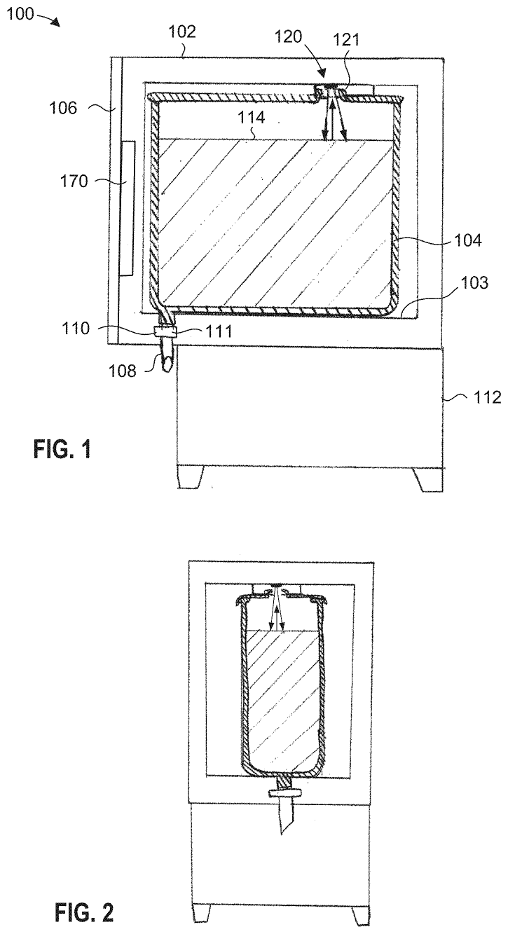

FIG. 1 is a diagram showing a side view of an example liquid dispensing apparatus 100 with an optical liquid height measuring system 120, according to a present embodiment. More specifically, FIG. 1 shows a side view of a liquid dispensing apparatus 100 having a container 102 for housing a tank 104, which may be removable. The container 102 has an interior bottom 103, and may be configured to prevent all external light from entering, however for the purposes of illustration in FIG. 1, a side wall has been omitted to show the components inside the container 102. FIG. 2 is a front view of the embodiment of FIG. 1.

Again referring to the embodiment of FIG. 1, the container 102 generally takes on the overall shape of a rectangular box, and includes a front door panel 106 which can be opened to allow for insertion and removal of tank 104. Although not shown in FIG. 1, the tank 104 can be slightly tilted towards the front door panel 106. The tank 104 includes an outlet nozzle 108 coupled to a dispense control system 110 that is mounted to the dispenser chassis 112. The dispenser chassis 112 may include legs/feet which can be individually adjusted to level the liquid dispensing apparatus 100. Dispense control system 110 comprises a valve 111 for controllably dispensing liquid from tank 104. In this example of FIG. 1, the dispense control system 110 includes an electronically controlled pinch valve 111 for closing and opening the outlet nozzle 108.

Optionally, although not shown, a top panel of container 102 may be hinged to form another door to allow top side access to the inside of container 102, It is noted that liquid storage tank 104 may have translucent or transparent walls and lid, and line 114 represents a surface of the liquid within tank 104. In an embodiment, liquid dispensing apparatus 100 may include one or both of a refrigeration system and a heating system for cooling or heating the liquid content of tank 104, respectively.

It is to be appreciated that, in other embodiments, features of liquid dispensing apparatus 100 described above in relation to FIG. 1 may differ.

The liquid height measuring system 120 of the liquid dispensing apparatus 100 according to one embodiment is now described. The liquid height measuring system 120 of the present embodiments includes an optical sensor device 121 for use in calculating the height or level of the liquid within tank 104,

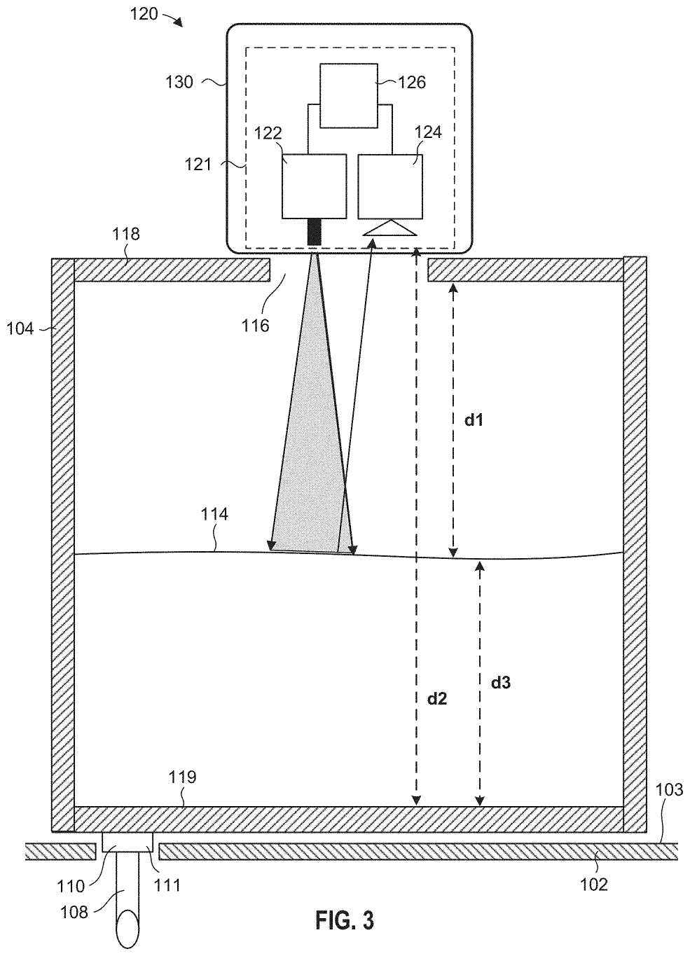

FIG. 3 is a diagram of an example optical sensor device 121 disposed at an upper opening 116 of tank 104. Optical sensor device 121 may be contained in a housing 130, which may protect device 121 from liquid and/or from manual handling, and/or provide for proper alignment of device 121 with tank 104. Further, housing 130 may selectively and releasably engage with a lid 118 of tank 104. Optical sensor device 121 is configured to measure a distance d1 between optical sensor device 121 and upper surface 114 of the liquid in the tank 104, and/or the bottom of tank 104 when the tank is empty. Optical sensor device 121 may also be used to measure a distance between optical sensor device 121 and bottom 103 of container 102 when tank 104 is removed. A bottom 119 of tank 104 is also shown, and a distance d2 between sensor 121 and bottom 119 is indicated. The opening 116 may be formed in lid 118 of tank 104.

Optical sensor device 121 generally comprises a light source 122 (e.g. emitter), such as laser, an infrared laser, light emitting diode (LED), or any other suitable light source, an optical sensor 124 (e.g. receiver), and a timer device 126. In operation, a light signal emitted from the light source 122 travels downwardly to the surface of the liquid 114 in tank 104. The light signal may be in any suitable form, such as a light pulse or series of pulses, and may be emitted periodically, intermittently, continuously, or on demand. In the embodiments of FIGS. 1-3, the light emitted from light source 122 is in a cone-like shape, expanding as the light gets farther away from source 122. Some of the light is reflected back by the top 114 of the liquid, or from bottom 119 of tank 104 when the tank is empty, or from bottom 103 of container 102 when the tank is removed, and travels back upwardly to and is received by the optical sensor 124. This path of travel of the light signal is denoted by the solid line arrows in FIG. 3. The timer device 126 measures the total time of flight of the light signal, meaning the time it takes the light signal to travel from light source 122 to the surface of the liquid 114 and back to optical sensor 124. The distance d1 between optical sensor device 121 and the surface 114 of the liquid may then be calculated using the total time of flight measurement, for example (time of flight*speed of light)/2. In an embodiment, optical sensor device 121 is a time-of-flight laser sensing device. The height of the surface 114 of the liquid from the bottom of the tank 104, distance d3, may be calculated using distance d1 and the known distance d2, namely d3=d2−d1.

Apparatus 100 may further include a processing system 170 (FIG. 1), which may be integrated into the front door panel 106, or at any other location of the liquid dispensing apparatus 100 or elsewhere. In an embodiment, processing system 170 may be located remotely from apparatus 100. As will be described further below, processing system 170 may include a microcontroller, a micro-processor, a computer processor, or any assembly of circuit or other devices interconnected and configured for the purposes including receiving signals from optical sensor device 121 and using them to calculate the height of the liquid in the tank.

While not shown in FIG. 1, the front door panel 106 may include a user interface system which may include a display to provide information, a user input panel for selecting dispense volumes and to execute other functions. As previously mentioned, the processing system 170 may be included in the front door panel 106 to control the dispense control system 110 in view of selections made on the user interface system and to calculate a level of the liquid in the tank 104 before or after a dispense operation. The display may be configured to always show a current level of the tank 104 after the previous dispense operation.

In the event that the front door panel 106 is opened for any reason, such as for refilling the tank 104 with the same liquid or to conduct simple maintenance, closing the door panel may automatically trigger a reset operation for the liquid height measuring system 120 to activate and determine the level of the liquid in the tank 104. This may be a beneficial function as it may be assumed in all cases that the tank 104 has been manually topped up with more of the same liquid and obviates the need for any user judgment to determine that a reset is required. Alternatively or additionally, the liquid height measuring system 120 may be configured to ignore height measurement readings taken while the door panel is open. For example, maintenance of the apparatus may cause erroneous liquid height measurements. Persons skilled in the art will understand any type of door sensor may easily be integrated with processing system 170 to provide this type of control. There may also be a manual dispense function that allows for any amount of liquid to be dispensed, where the liquid height measuring system 120 is activated after the manual dispense operation has ended.

Electrical signals from optical sensor device 121 are provided to the processing system 170 for the calculation of the level of liquid in tank 104. Again, the processing system 170 may use one or more liquid height measurements from optical sensor device 121 in combination with other information including the distance d2 between the optical sensor device 121 and the bottom of tank 104 to calculate the liquid level 114 in tank 104.

This liquid height may be displayed on the user interface to indicate that the liquid dispensing apparatus 100 is now ready to dispense either alone or in conjunction with some other visual indicator.

Once the height of the liquid in tank 104 has been determined using optical sensor device 121, then the head pressure of the liquid inside the tank may be calculated based on the measured height, and optionally using other information and/or fluid dynamic equations. The head pressure information may then be used to calculate an open time of valve 111 of the dispense control system 110 in order to dispense an exact dose of liquid.

The liquid height measuring system 120 may be activated to take a measurement at any suitable times or according to any suitable schedule. For example, the liquid height measuring system 120 may be activated in response to one or more of the following events: before and/or after the completion of a dispense operation, after the closing of front panel 106, upon startup and/or a reset of processing system 107, at a scheduled time, and a user input requesting a measurement.

An “empty” threshold may be set in the processing system to indicate on the user interface when the liquid level in the tank has dropped to below a level in which further reliably accurate dispenses are no longer possible. Other similar predetermined thresholds may also be set in the processing system.

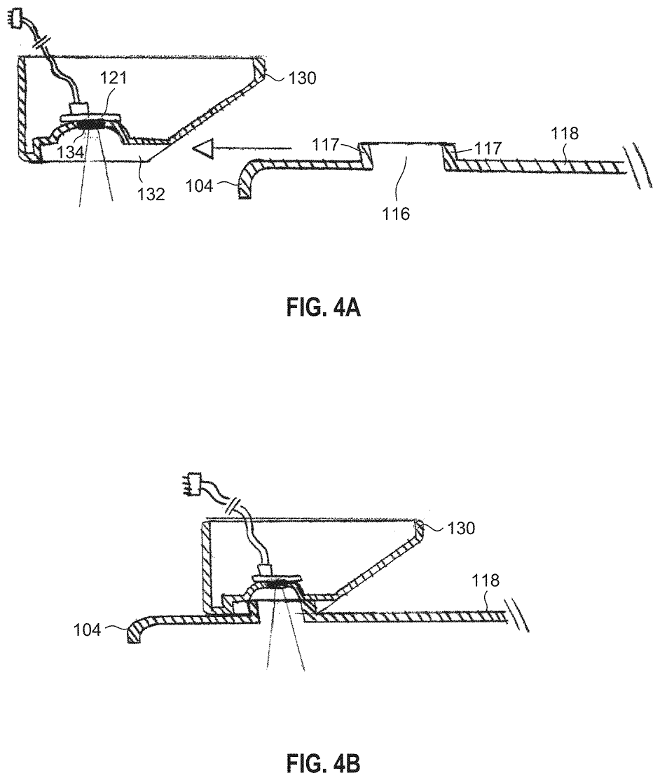

FIG. 4A shows, in an embodiment, a lid or top 118 of tank 104 and sensor housing 130 for receiving optical sensor device 121. Housing 130 is releasably, and optionally sealingly, engageable with lid 118 at the location of opening 116 in lid 118. In this embodiment, housing 130 defines a region 132 for engaging an annular flange 117 extending upwardly from lid 118 at opening 116 thereby permitting a sliding engagement of housing 130 with lid 118. Housing 130 may define a port 134 allowing for light to pass in and out of the housing.

FIG. 4B shows housing 130 engaged with lid 118. Of course, in other embodiments, housing may engage with lid 118 in any other suitable manner.

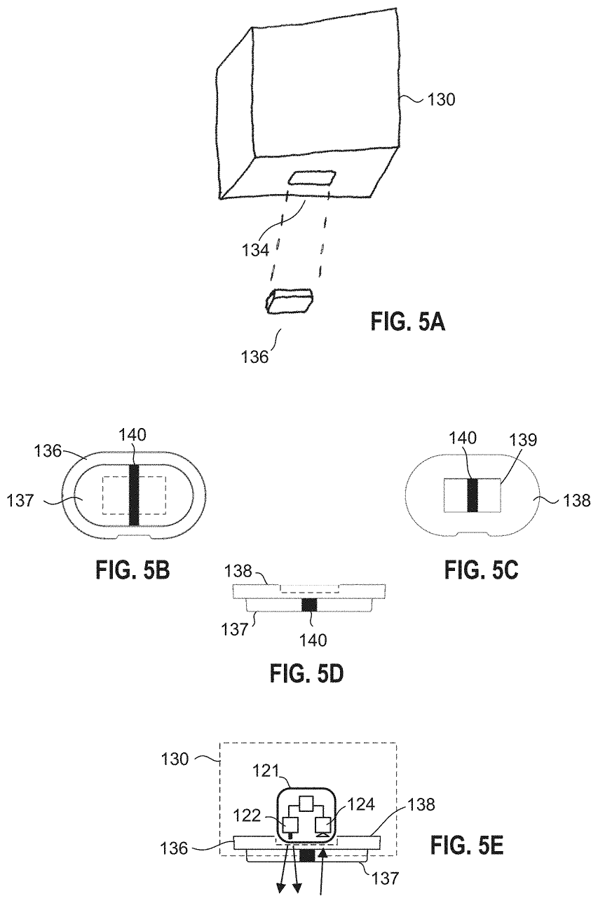

FIG. 5A is a bottom perspective view of a simple block representation of housing 130 to illustrate port 134 and a sensor cover 136, in an exploded fashion. Port 134 may comprise, define or be fitted with a sensor cover 136 to fluidly seal the port 134 while still allowing for passage of light,

FIG. 5B is a view of a first side 137 of an embodiment of sensor cover 136. FIG. 5C is a view of a second side 138 of sensor cover 136 of FIG. 5B. FIG. 5D is a side view of sensor cover 136 of FIG. 5B. Sensor cover 136 may be partially or wholly formed from a layer(s) of material(s) that allows light to pass therethrough, such as acrylic or any other suitable material. The layer may be transparent. First side 137 of cover 136 may be oriented to face into tank 104, while second side 138 may be oriented to face into housing 130. Second side 138 may define a recessed portion 139, as shown in FIG. 5C, for receiving optical sensor device 121. Recess portion 139 is indicated with broken lines in FIGS. 5B and 5D. Sensor cover 136 may comprise a separation wall 140, comprising an opaque material for blocking light, for positioning between the emitter 122 and receiver 124 of the optical sensor device 121. Separation wall 140 may prevent or reduce light immediately leaving emitter 122 from being detected by receiver 124, which could cause inaccurate time of flight readings by optical sensor device 121.

FIG. 5E shows an optical sensor device 121 positioned at recess 139 of sensor cover 136 with arrows representing light leaving emitter 122 and being received at receiver 124 through sensor cover 136. A broken line represents housing 130.

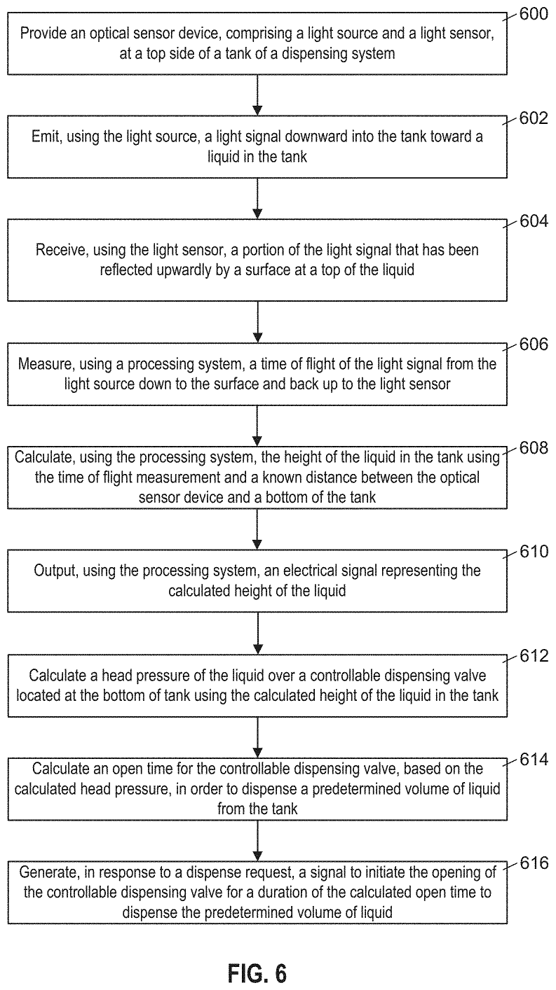

FIG. 6 is a process flow diagram of an example method according to an embodiment of the present disclosure. The process starts at block 600 wherein an optical sensor device is provided, comprising a light source and a light sensor, at a top side of a tank of a dispensing system. The process proceeds to block 602, wherein a light signal is emitted, using the light source, downward into the tank toward a liquid in the tank. The process proceeds to block 604 wherein a portion of the light signal that has been reflected upwardly by a surface at a top of the liquid is received using the light sensor.

The process proceeds to block 606 wherein a time of flight of the light signal from the light source down to the surface and back up to the light sensor is measured using a processing system. The process proceeds to block 608 wherein the height of the liquid in the tank using the time of flight measurement and a known distance between the optical sensor device and a bottom of the tank is calculated using the processing system. The process proceeds to block 610 wherein, optionally, an electrical signal representing the calculated height of the liquid is outputted using the processing system. The signal may be received by one or more subsystems of the dispensing apparatus, such as the dispensing control system and/or the user interface system.

The process proceeds to block 612 wherein a head pressure of the liquid over a controllable dispensing valve 111 located at the bottom of tank is calculated using the calculated height of the liquid in the tank. The process proceeds to block 614 wherein an open time for controllable dispensing valve 111, based on the calculated head pressure, is calculated in order to dispense a predetermined volume of liquid from the tank. The process proceeds to block 616 wherein, in response to a dispense request, a signal is generated to initiate the opening of controllable dispensing valve 111 for a duration of the calculated open time to dispense the predetermined volume of liquid. The steps in blocks 612, 614, and 616 are optional.

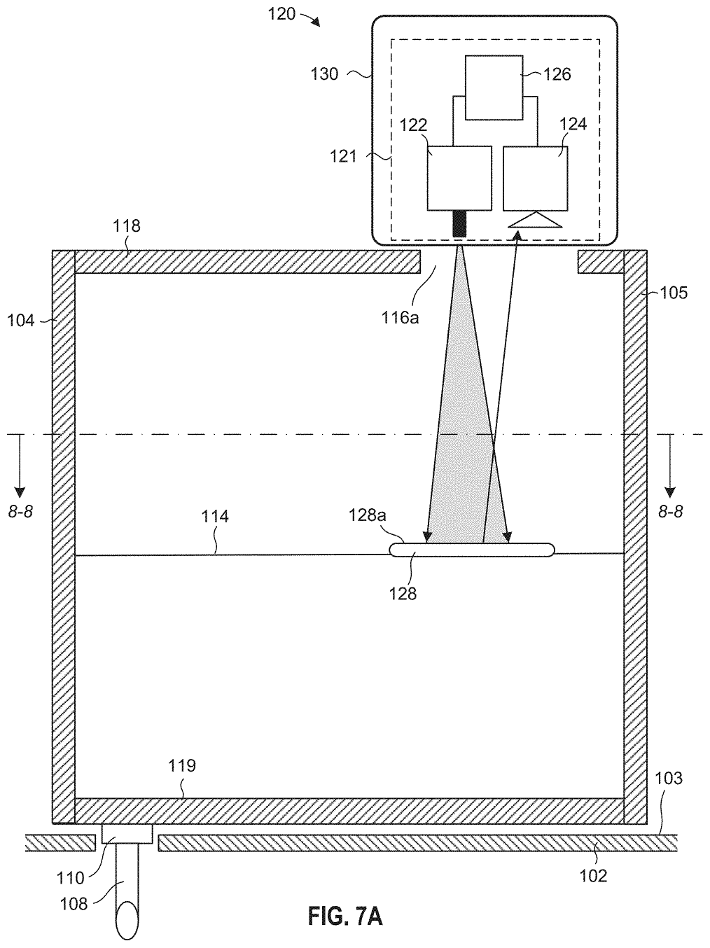

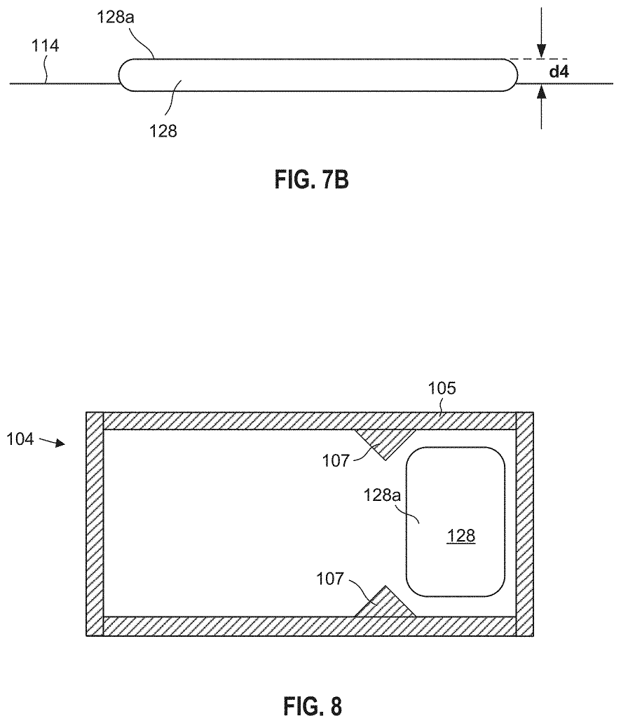

FIG. 7A is a diagram of an example optical liquid height measuring system 120 comprising an optical sensor device 121 disposed at an upper opening 116a of tank 104. This embodiment is similar to the one of FIG. 3 except in that optical liquid height measuring system 120 further includes a reflective float 128 disposable within tank 104 to float at the surface of liquid 114. Also, opening 116a is located in a different location, namely closer to one of the side walls of tank 104.

Optical liquid height measuring system 120 often works best when it has a smooth, consistently reflective surface that allows the light to be returned to the optical sensor 124 of device 121. Certain liquids do not provide this optical stability, which can produce unpredictable effects on distance measurements by system 120. To overcome this problem, a reflective float 128, which sits close to the upper liquid surface, may be used in optical liquid height measuring system 120.

In operation, a light signal emitted from the light source 122 travels downwardly to the surface of the liquid 114 in tank 104. In this embodiment, rather than some of the light being reflected back by the liquid surface 114, as is the case with the embodiment of FIG. 3, here some of the light is reflected back by top surface 128a of float 128, which is located at the top of the liquid in tank 104. For descriptive purposes, top surface 128a may be considered to be at the top surface of the liquid even though top surface 128a may actually be a bit higher than the top of the liquid. Float 128 rises and falls in accord with the changing liquid level to provide accurate distance measurements. Again, use of float 138 in system 120 may overcome the problem with certain liquids not providing sufficient optical stability.

Reflective float 128 may have any suitable shape and size, but in at least some embodiments has a smooth and level reflective upper surface 128a for reflecting light emitted by optical sensor device 121. Float 128 may be made of any suitable material(s), including plastic. In an embodiment, at least upper surface 128a, or entire float 128, will be opaque or substantially opaque to reflect light back to device 121. Further, in an embodiment, float 128 is flat and smooth. A rougher upper surface 128a finish would work but if the surface roughness exceeds, for example 1 mm, then the accuracy of the distance measurements may lessen. In addition, in some embodiments, the colour of float 128 will be light, for example white or light grey, to permit for easy visual inspection for cleanliness.

FIG. 7B is an enlarged view of float 128 at surface of liquid 114. Depending on the thickness of float 128 and the material from which it is made, a slight adjustment of the distance measurement calculation may be made to account for a height d4 by which float 128 extends above the liquid. For example, the measured distance to float 128 from device 121 may be adjusted by adding distance d4, which in turn would reduce the calculated height of liquid in tank 104 by the same d4 amount. In some embodiments, height d4 may considered negligible and thus the calculation may not be altered.

Float 128 may be captured, tethered, or otherwise retained in some way in alignment with optical sensor device 121. FIG. 8 is top cross sectional view of tank 104 taken along line 8-8 in FIG. 7A. As shown in FIG. 8, in at least one embodiment, guide means in the form of structural features within tank 104 may be provided to retain float 128 in vertical alignment with device 121. In this embodiment, the structural features are in the form of guides 107 oriented substantially vertically and extending inwardly from walls 105 of tank 104 to retain and guide float 128 within a defined region of tank 104 so that float 128 remains in alignment with optical sensor device 121. As the liquid level falls and rises, float 128 is prevented by guides 107 from leaving the defined region within tank 104. It is to be appreciated that the size, shape, and configuration of guides 107 in FIG. 8 are only examples and that one or more guides having other shapes and configurations may be used. Moreover, it is also to be appreciated that other types of guide means may be used in place or in addition to guides 107 of FIG. 8.

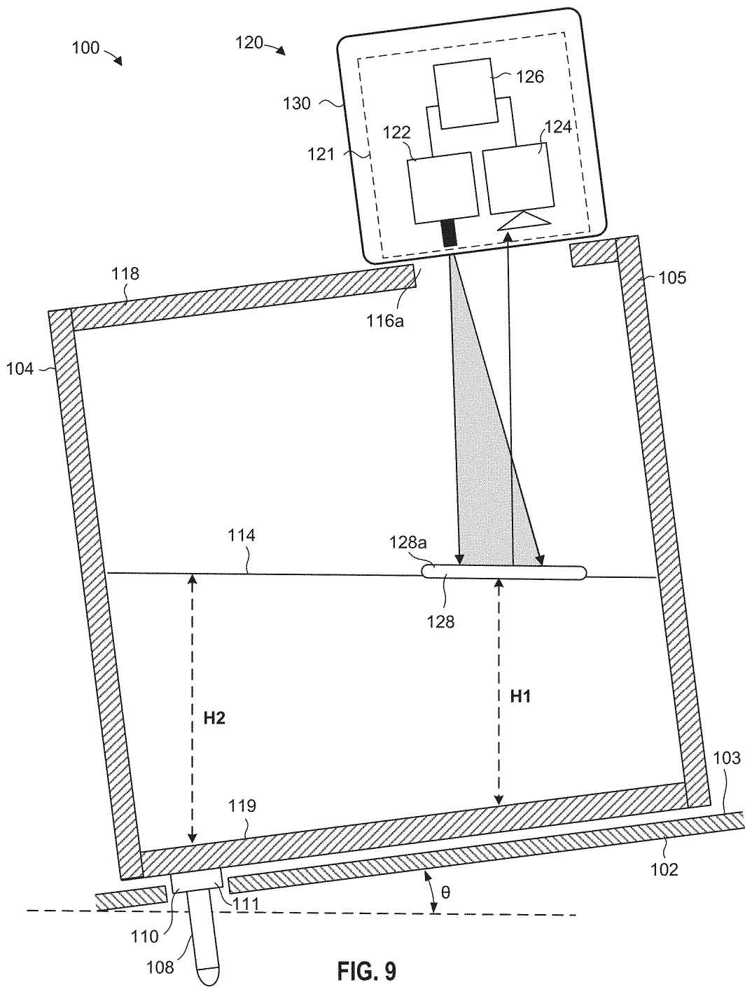

FIG. 9 is a diagram of an example optical liquid height measuring system 120 similar to the one of FIG. 7A except here dispensing apparatus 100 and thus tank 104 is not level, as indicated by the tilt of apparatus 100 in the figure and by surface 114 of the liquid in tank 104. Here, apparatus 100 is unlevel due to positioning on an unlevel surface, as opposed to a situation where the bottom of tank 104 is intentionally sloped, for example sloped toward valve 111. Since optical sensor device 121 is not located directly above the dispense valve 111, the liquid level measured by optical sensor device 121 will be different than the liquid level at dispense valve 111. In FIG. 9, the measured liquid height H1 is different (here less than) liquid level H2 directly above valve 111. As a result, the head pressure at valve 111 determined based on the measured liquid height H1 will be incorrect, and may result in an incorrect dispense volume.

One or more accelerometers or other sensor(s) may be used to detect and/or measure an angle of inclination e of dispensing apparatus 100. The measurement(s) may be used by a processor, for example a processor of processing system 170 (FIG. 1), in calculations to add or remove height from a measured height of liquid over valve 111 to compensate for the incline. Such calculations may use trigonometry, the measured angle of inclination, and/or known distances such as the dimensions of tank 104, distance between the location where the liquid height is measured and valve 111, etc. The accelerometer(s) or other sensor(s) may be positioned in any suitable location in liquid dispensing apparatus 100. Further, in some embodiments, the inclination may be measured along two axes parallel to horizontal level.

Aspects of the present disclosure may be implemented on any suitable apparatus or apparatuses, which may include one or more computers and/or computer related components. The teachings of the present disclosure may be implemented at or performed by any network element or combination of network elements. A network element may be a network side electronic device, such as a server, or a user side electronic device, such as mobile device or other personal electronic device. These network side and user side devices are only examples and are not intended to be limiting.

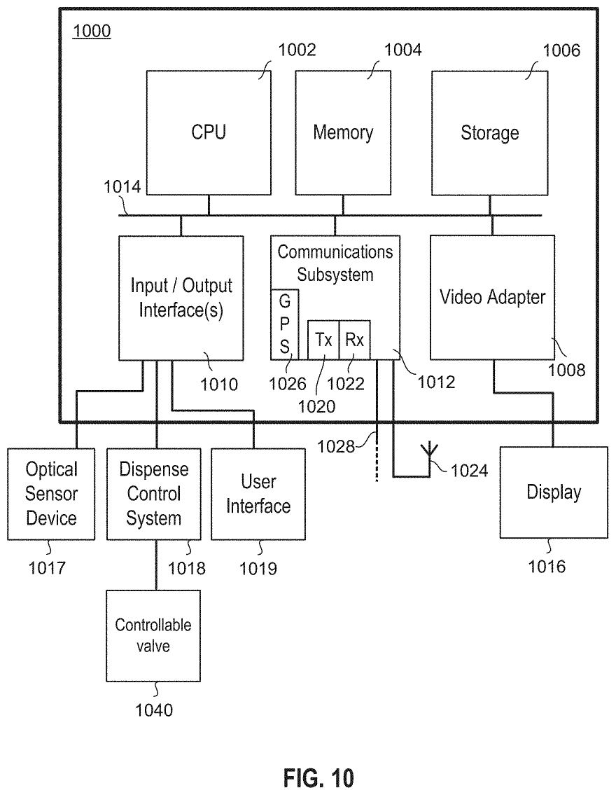

FIG. 10 is a block diagram of an example electronic device 1000 that may be used in implementing one or more embodiments of the present disclosure. For instance, device 1000 may be used to implement processing system 170 or any other computerized device or system according to the present disclosure. The electronic device 1000 may be any suitable type of device or combination of devices, including but not limited to an embedded system, a system on chip, a mobile device, a smartphone, a tablet, a notebook computer, a desktop computer, a server, and a mainframe.

The electronic device 1000 may include one or more of a central processing unit (CPU) 1002, memory 1004, a mass storage device 1006, a video adapter 1008, an input/output (I/O) interface 1010, and a communications subsystem 1012. One or more of the components or subsystems of electronic device 1000 may be interconnected by way of one or more buses 1014 or in any other suitable manner.

The bus 1014 may be one or more of any type of several bus architectures including a memory bus or memory controller, a video bus, peripheral bus, or the like. The CPU 1002 may comprise any type of electronic data processor. The memory 1004 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The mass storage device 1006 may comprise any type of storage device configured to store data, programs, and other information and to make the data, programs, and other information accessible via the bus 1014. The mass storage device may comprise, for example, one or more of a solid state drive, hard disk drive, a magnetic disk drive, an optical disk drive, or the like. In some embodiments, data, programs, or other information may be stored remotely, for example in the “cloud”. Electronic device 1000 may send or receive information to the remote storage in any suitable way, including via communications subsystem 1012 over a network or other data connection.

The video adapter 1008 and the I/O interface 1010 may provide interfaces to couple external input and output devices to the electronic device. As illustrated, examples of input and output devices include a display 1016 coupled to the video adapter 1008, and an optical sensor device 1017, a dispense control system 1018, and a user interface 1019 all commutatively coupled to the I/O interface 1010. Dispense control system 1018 may be commutatively coupled to, or otherwise include, a controllable valve 1040 for selectively dispensing a predetermined volume of liquid. Other types of possible sensors, not shown, may include but are not limited to one or more accelerometers, pressure sensors, light sensors, acoustic sensors, and temperature sensors. For example, an accelerometer or other sensor may be used to measure and compensate for an unlevel dispenser when the optical sensor device is not superimposed over the dispense valve. The accelerometer may be used to adjust the measured height of the liquid over the dispense valve and subsequently the head pressure. It is to be appreciated, however, that these peripherals and other devices are examples only. Other devices may be coupled or connected to the electronic device in addition to or in place of those shown and described. Furthermore, additional or fewer interfaces may be utilized. For example, one or more serial interfaces such as Universal Serial Bus (USB) (not shown) may be provided.

A communications subsystem 1012 may be provided for one or both of transmitting and receiving signals. Signals may include one or more of configuration information, log information, control information. Communications subsystems may include any component or collection of components for enabling communications over one or more wired and wireless interfaces. These interfaces may include but are not limited to USB, Ethernet, high-definition multimedia interface (HDMI), Firewire™ (e.g. IEEE 1394), Thunderbolt™, WiFi™ (e.g. IEEE 802.11) WiMAX (e.g. IEEE 802.16), Bluetooth™, or Near-field communications (NFC), as well as GPRS, UMTS, LTE, LTE-A, dedicated short range communication (DSRC), and IEEE 802.11.

Communication subsystem 1012 may include one or more ports or other hardware 1028 for one or more wired connections. In addition, communication subsystem 1012 may include one or more of transmitters 1020, receivers 1022, and antenna elements 1024. In at least some embodiments, the electronic device may have geographic positioning functionality, for example to determine a geographical position of the electronic device or for receiving timing signals for time synchronization of the device with other systems. In at least some embodiments, the electronic device may be capable of receiving Global Positioning System (GPS) signals. Therefore in at least one embodiment, as shown in FIG. 10, the electronic device may comprise a GPS radio or receiver 1026. However, other embodiments may comprise and use other subsystems or components for, for example, determining the geographical position of the electronic device or for receiving timing signals for time synchronization. In some embodiments, the electronic device may be configured to determine a geographic location using WiFi.

The electronic device 1000 of FIG. 10 is merely an example and is not meant to be limiting. Various embodiments may utilize some or all of the components shown or described. Some embodiments may use other components not shown or described but known to persons skilled in the art. Furthermore, a device may contain multiple instances of a component, such as multiple electronic device, processors, memories, transmitters, receivers, etc. The electronic device may comprise one or more input/output devices, such as a speaker, microphone, mouse, touchscreen, keypad, keyboard, display, and the like. Various other options and configurations are contemplated.

The previously described embodiments show a configuration where the dispensing apparatus houses a single tank. In an alternate embodiment, not shown, the dispensing apparatus may house two or more tanks , for example, in a side-by-side or any other suitable arrangement. An optical sensor device 121 may be provided for each separate tank. During operation, the plurality of optical sensor devices 121 may be activated at different times to take measurements in an attempt to achieve more accurate readings by avoiding influence from the other optical sensor devices. Processing system 170 may control the activation of the optical sensor devices 121 in this manner.

In an embodiment, averaging and filtering is used to improve precision of the sensor readings. For instance, electrical signals from optical sensor device 121 may be provided in one millimeter resolution and the readings may dither between two or more adjacent values and as such the processing system 170 may calculate an average of multiple readings with sub-millimeter resolution. Successive averages may be further smoothed with a first order digital filter, a weighted average of the most current reading average and the most recent filtered value, to remove noise or wave/ripples on the liquid surface.

In an embodiment, dispensing apparatus 100 is configured to identify and discard measurements made by optical sensor devices 121 having obstructed optical paths (e.g. dirty due to residue, etc, within the tank). For instance, a time of flight measurement, or a calculated distance, that would never occur with a clean sensor may be identified since they do not fall within a known range of possible values for the given parameters of a system. Optionally, such measurements may trigger a notification or alarm to alert a user that the apparatus requires cleaning.

In an embodiment, a degradation of the accuracy of the dispensing apparatus may be identified, profiled, and corrected. For example, the valve open time for a first dispense after 12 hours of no use of the dispensing apparatus may need to be increased by 10% to account for the outlet nozzle 108 opening more slowly than the pinch valve due to being stuck closed, having taken a set, or a film of dried liquid (e.g. dairy product) inside the outlet nozzle below the pinch point.

In an embodiment, dispensing apparatus 100 may include a temperature sensor at the optical sensing device 121 to allow for compensation of the time of flight measurements. For example, changes in the ambient temperature around a laser light source of the optical sensing device 121 may affect the laser and thereby affect the measurements.

In an embodiment, if the difference between the most current reading average and the current first order digital filter is positive and greater than a predetermined threshold then the processing system 170 may flag the detection of a tank filling event. When a tank filling event is flagged, the current first order digital filter value may be replaced with the current reading average, effectively eliminating the time constant of the first order digital filter to respond to the tank filling event.

In an embodiment, the processing system 170, controlling the dispensing events, may replace the first order digital filter value with the predicted post dispense tank level value, and as such may eliminate or bypass the time constant for the filter to respond to the new lower tank level.

In an embodiment, the present apparatus and method may be used with a non-transparent liquid to be dispensed, such as a liquid dairy product. The non-transparent property of the liquid generally enhances the reflectivity of the upper of the surface of the liquid.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure may be represented as a computer program product stored in a non-transitory machine-readable medium (also referred to as a computer-readable medium, a processor-readable medium, or a computer usable medium having a computer-readable program code embodied therein). The machine-readable medium may be any suitable tangible, non-transitory medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations may also be stored on the machine-readable medium. The instructions stored on the machine-readable medium may be executed by a processor or other suitable processing device, and may interface with circuitry to perform the described tasks.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

In addition, the steps and the ordering of the steps of methods described herein are not meant to be limiting. Methods comprising different steps, different number of steps, and/or different ordering of steps are also contemplated.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The above-described embodiments are intended to be examples only. Alterations, modifications and variations can be effected to the particular embodiments by those of skill in the art without departing from the scope, which is defined solely by the claims appended hereto.

1. An apparatus for use in a liquid dispensing system, comprising:
an optical sensor device disposable at a top side of a tank of the dispensing system, the optical sensor device comprising:
a light source for emitting a light signal downward into the tank toward a liquid in the tank;
a light sensor for receiving a portion of the light signal that has been reflected upwardly by a surface at a top of the liquid;
a processing system for measuring a time of flight of the light signal from the light source down to the surface at the top of the liquid and back up to the light sensor, and for calculating the height of the liquid in the tank using the time of flight measurement and a known distance between the optical sensor device and a bottom of the tank, and for outputting an electrical signal representing the calculated height of the liquid.

2. The apparatus of claim 1, wherein the processing system is configured to calculate a head pressure of the liquid over a controllable dispensing valve located at the bottom of tank using the calculated height of the liquid in the tank.

3. The apparatus of claim 2, wherein the processing system is configured to calculate an open time for the controllable dispensing valve, based on the calculated head pressure, in order to dispense a predetermined volume of liquid from the tank.

4. The apparatus of claim 3, wherein the processing system generates, in response to a dispense request, a signal to initiate the opening of the controllable dispensing valve for a duration of the calculated open time to dispense the predetermined volume of liquid.

5. The apparatus of claim 1, wherein the surface for reflecting a portion of the light signal is an upper surface of the liquid.

6. The apparatus of claim 1, further comprising a reflective float disposable within the tank for floating at the surface of the liquid, wherein the surface at the top of the liquid for reflecting the light is a surface of the reflective float.

7. The apparatus of claim 6, further comprising a guide for retaining the reflective float in substantial vertical alignment with the optical sensor device.

8. The apparatus of claim 1, further comprising a sensor for measuring an angle of inclination of the apparatus from level, wherein the processing system is further configured to adjust the calculated height of the liquid in the tank based on the measured angle.

9. The apparatus of claim 1, wherein the optical sensor device is a time of flight laser device.

10. A method comprising:
providing an optical sensor device, comprising a light source and a light sensor, at a top side of a tank of a dispensing system;
emitting, using the light source, a light signal downward into the tank toward a liquid in the tank;
receiving, using the light sensor, a portion of the light signal that has been reflected upwardly by a surface at a top of the liquid;
measuring, using a processing system, a time of flight of he light signal from the light source down to the surface and back up to the light sensor;
calculating, using the processing system, the height of the liquid in the tank using the time of flight measurement and a known distance between the optical sensor device and a bottom of the tank;
outputting, using the processing system, an electrical signal representing the calculated height of the liquid.

11. The method of claim 10, further comprising calculating a head pressure of the liquid over a controllable dispensing valve located at the bottom of tank using the calculated height of the liquid in the tank.

12. The method of claim 11, further comprising calculating an open time for the controllable dispensing valve, based on the calculated head pressure, in order to dispense a predetermined volume of liquid from the tank.

13. The method of claim 12, further comprising generating, in response to a dispense request, a signal to initiate the opening of the controllable dispensing valve for a duration of the calculated open time to dispense the predetermined volume of liquid.

14. The method of claim 10, wherein the surface for reflecting a portion of the light signal is an upper surface of the liquid.

15. The method of claim 10, wherein the surface at the top of the liquid for reflecting the light is a surface of a reflective float disposed within the tank.

16. The method of claim 15, further comprising guiding the reflective float within the tank to retain the reflective float in substantial vertical alignment with the optical sensor device.

17. The method of claim 10, further comprising:
measuring, using a sensor, an angle of inclination of the dispensing system from level; and
adjusting, using the processing system, the calculated height of the liquid in the tank based on the measured angle.

18. The method of claim 10, wherein the emitting the light signal comprises emitting a laser beam.
